(19) United States
(12) Patent Application Publication
(10) Pub. No.: US 2019/0093421 A1
(43) Pub. Date: Mar. 28, 2019

(54) SECURELY ATTACHABLE EXTENSION PANELS FOR DOORS

(71) Applicant: Aurora Systems Inc., Everett, WA (US)

(72) Inventors: Dustin Dale Swartz, Bothell, WA (US); Ryan Martin, Stanwood, WA (US); Gregory J. Goldfinch, Everett, WA (US)

(21) Appl. No.: 16/135,607

(22) Filed: Sep. 19, 2018

Related U.S. Application Data
(60) Provisional application No. 62/563,484, filed on Sep. 26, 2017.

(51) Int. Cl. E06B 7/232; E06B 3/46; E06B 7/18

(52) U.S. Cl. CPC E06B 7/232; E06B 2003/7096; E06B 7/18; E06B 3/4636

(57) ABSTRACT

Systems and devices for providing extension panels for doors. The extension panels may be physically coupled to the door using, for example, a bracket that may be coupled along a vertical edge and/or top edge or bottom edge of the door. In some instances, the bracket may include a channel that may be sized and shaped to receive and securely engage an elongated pin that may be physically attached to the extension panel. In some implementations, the bracket may include an H-shaped bracket that forms two cavities. One of the cavities may engage a portion of the extension panel and the other cavity may engage a portion of the door to physically couple the extension panel and the cavity.

### TECHNICAL FIELD

The present disclosure generally relates to attachable panels that may be physically coupled to doors to extend the height and/or width of doors.

### BACKGROUND

### Description of the Related Art

In various environments, doors may be used to provide space savings and other benefits. Such doors may be comprised, for example, of sliding door panels, swinging door panels, folding door panels, and rotatable door panels. Such environments may include medical clinics, hospital exam rooms, toilet rooms or restrooms, corporate office settings, etc., where in particular the space savings and other functionality of doors may be desired. Some doors may be designed to roll on a track positioned at the top of the door frame, and it may be desirable to have a relatively low sound transmission to provide enhanced privacy and noise reduction between the two areas which are separated by a door.

### BRIEF SUMMARY

It may be desirable to reduce or eliminate side-gaps in existing doors having a door panel that does not extend the entire width of height of the door opening. In some instances, delivering and installing an oversized door (e.g., a 55 inch wide door) may be expensive and impractical. Accordingly, extension panels may be physically coupled to and installed on standard sized doors that are 48 inches wide, for example, to provide an extended door having a greater width (e.g., 55 inches or more).

An extension panel apparatus for a door having a length, a width, and a height, the door which has two opposing vertical edges located across the length of the door and that extend along the height of the door, a front face and an opposing back face separated by the width of the door, and a top edge and an opposing bottom edge located across the height of the door, the extension panel apparatus, may be summarized as including: an extension panel, the extension panel which has a length, a width, and a height, and which includes a two vertical edges separated by the length of the extension panel; at least one elongated pin, the at least one elongate pin which extends outward from one of the vertical edges; and a connector, the connector which is physically coupled to the door and which physically engages with the at least one elongated pin to securely, physically, detachably couple the extension panel to the door along one of the vertical edges.

The height of the extension panel may align with the height of the door when the extension panel is securely, physically, detachably coupled to the door. The elongated pin may extend outward from the width of the extension panel, wherein the connector may include a bracket comprised of a channel having an open end facing upward and an opposing closed end, and wherein the elongated pin may be sized and dimensioned to be insertable into the open end of the channel and to be physically, detachably, coupleable to the connector when engaged at the closed end of the channel. The connector may be located within a cavity located along one of the vertical edges of the door. The elongated pin may have a head portion that is insertable into the open end of the channel. The bracket may further include a tab that physically, securely, detachably engages with the elongated pin when the elongated pin is inserted into the closed end of the channel. The extension panel may include a groove formed along at least one of the vertical edges of the extension panel, wherein the door may be sized and dimensioned to fit at least a portion of the door into the groove such that the front face and the back face of the door align with corresponding portions of the extension panel. At least a portion of the connector may extend past at least one of the vertical edges of the door and may securely physically couple to the top edge of the door. The elongated pin may include a screw, wherein the screw may be physically insertable into a corresponding aperture in the connector. A recess may be formed along the top edge of the door, and wherein the recess may be sized, shaped, and positioned to receive the connector such that an upward-facing surface of the connector aligns with the top edge of the door.

The extension panel apparatus may further include a second connector, wherein at least a portion of the second connector extends past the at least one vertical edge of the door and securely physically couples to the bottom edge of the door.

The extension panel apparatus may further include: a second extension panel, the second extension panel which has a length, a width, and a height, and which includes a two vertical edges separated by the length of the second extension panel; a second elongated pin, the second elongated pin which extends outward from one of the vertical edges of the second extension panel; and a second connector, the second connector which physically engages with the second elongated pin to physically couple the second extension panel adjacent to the other one of the vertical sides of the door.

The height of the second extension panel may align with the height of the door. The extension panel may have a front face and an opposing back face, the front face and the back face separated by the width of the extension panel, wherein the extension panel may further include a first leg that extends laterally from the front face of the extension panel, and a second leg that opposes the first leg and extends laterally from the back face of the extension panel, the first leg and the second leg forming a groove that at least partially extends around the front face and the back face of the door when the extension panel is detachably, physically coupled to the door.

An extension panel apparatus for a door having a length, a width, and a height, the door which has two opposing vertical edges located across the length of the door and that extend along the height of the door, a front face and an opposing back face separated by the width of the door, a top edge and an opposing bottom edge located across the height of the door, and a first door groove on the front face that extends from the top edge to the bottom edge and a second door groove on the back face that extends from the top edge to the bottom edge, the extension panel apparatus may be summarized as including: an extension panel, the extension panel which has a length, a width, a height, a front face, a back face, and a first extender groove on the front face of the extension panel and a second extender groove on the back face of the extension panel, the first extender groove and the second extender groove which extend along the height of the extension panel; and a bracket, the bracket having a first plate, an opposing second plate, and a cross-member, the cross-member which connects the first plate and the second plate of the bracket to form a first cavity and a second cavity, the first cavity of which is sized and dimensioned to detachably, securely engage and partially surround at least one vertical edge of the door and the second cavity of which is sized and dimensioned to detachably, securely engage and partially surround at least a portion of the extension panel.

The bracket may include a first set of two engageable ridge opposite each other across the first cavity and second set of two engageable ridges opposite each other across the second cavity, wherein each of the engageable ridges in the first set may be sized and dimensioned to securely, physically couple with the first door groove and the second door groove in the door, and wherein each of the engageable ridges in the second set of engageable ridges may be sized and dimensioned to securely, physically couple with the first extender groove and the second extender groove in the extension panel. The bracket may extends along the height of the door.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1A is an elevational view of an extension panel apparatus physically coupled to a door panel in a sliding door configuration such that the extension panel apparatus extends the sides of the door panel, according to at least one illustrated implementation.

FIG. 1B is an elevational view of an extension panel apparatus physically coupled to a door panel in a rotating door configuration such that the extension panel apparatus extends the sides of the door panel, according to at least one illustrated implementation.

FIG. 1C is an elevational view of an extension panel apparatus physically coupled to one door panel in a multiple-door panel, swinging door configuration such that the extension panel apparatus extends the sides of the door panel, according to at least one illustrated implementation.

FIG. 1D is an elevational view of an extension panel apparatus physically coupled to a door panel in a folding door configuration such that the extension panel apparatus extends the sides of the door panel, according to at least one illustrated implementation.

FIG. 2 is an exploded elevational view of an implementation of the extension panel apparatus in which extension panels of the extension panel apparatus couple with the door panel via brackets and corresponding elongated pins, according to at least one illustrated implementation.

FIG. 3 is an isometric view of a non-locking bracket that may be used to couple an extension panel with a door panel, according to at least one illustrated implementation.

FIG. 4 is an isometric view of a locking bracket that may be used to couple an extension panel with a door panel, according to at least one illustrated implementation.

FIG. 5 is an isometric exploded view of an extension panel apparatus that includes top-mounted brackets and bottom-mounted brackets that couple the extension panels to the door panel, according to at least one illustrated implementation.

FIG. 6 is a top plan view of an extension panel that includes a groove that may extend along a vertical edge of the extension panel that is proximate the door panel when the extension panel is coupled to the door panel, according to at least one illustrated implementation.

FIG. 7 is an exploded isometric view of an extension panel apparatus that includes a first cover panel and a second cover panel that are mounted over a junction of the door and a left extension panel of the extension panel apparatus, according to one illustrated implementation.

FIG. 8 is an isometric view of an extension panel apparatus in which an extension panel is comprised of a filler component and a cap component, according to at least one illustrated implementation.

FIG. 9 is a top plan view of an H-bracket that may be used to couple a door panel and extension panel together, according to at least one illustrated implementation.

FIG. 10 is an isometric view of an extension panel apparatus in which an H-bracket couples an extension panel with a door panel, according to at least one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

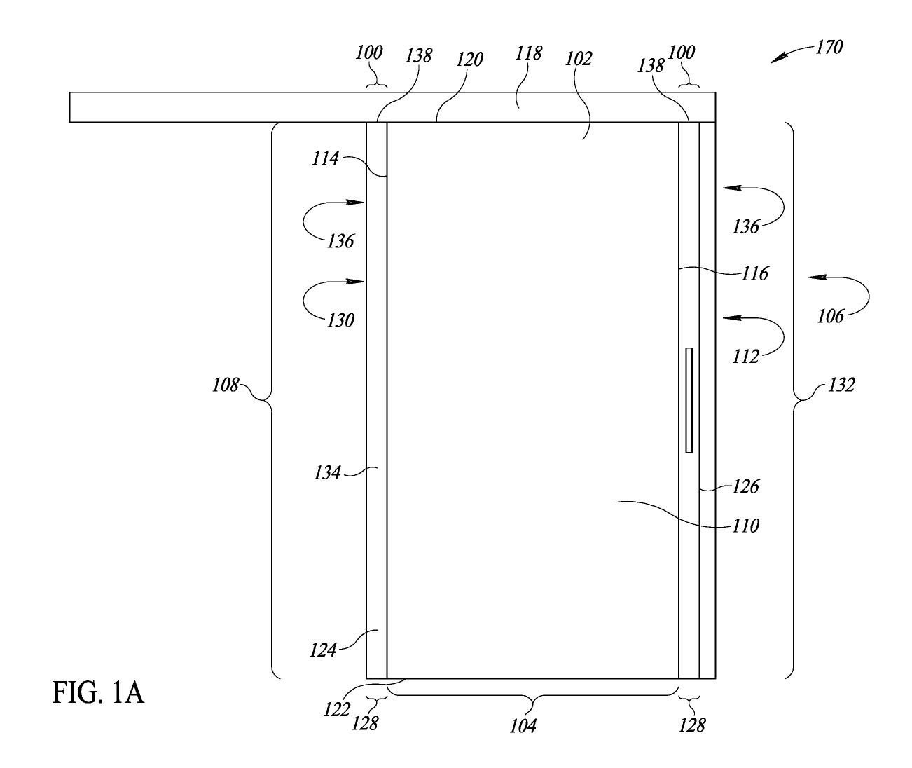

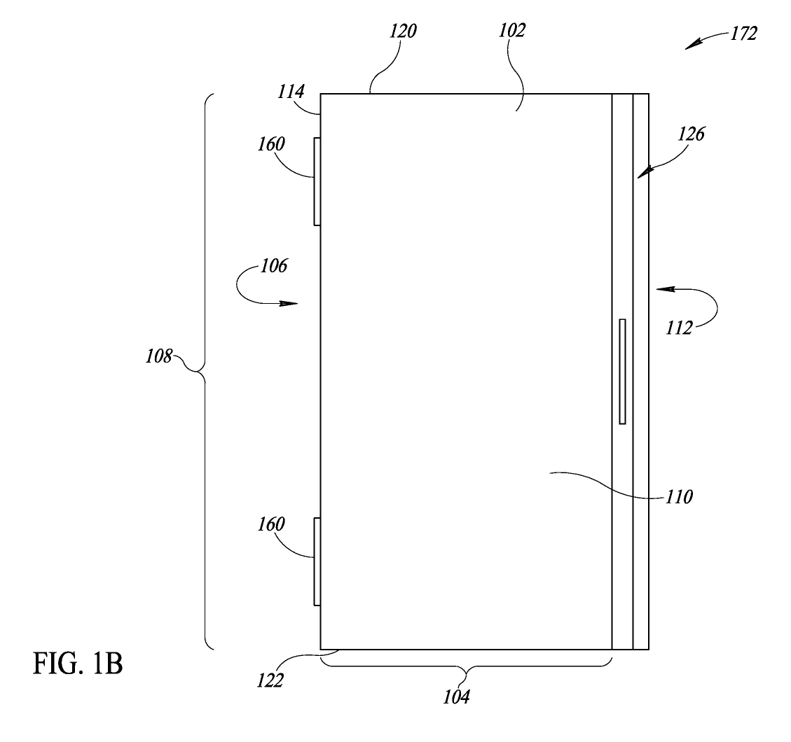

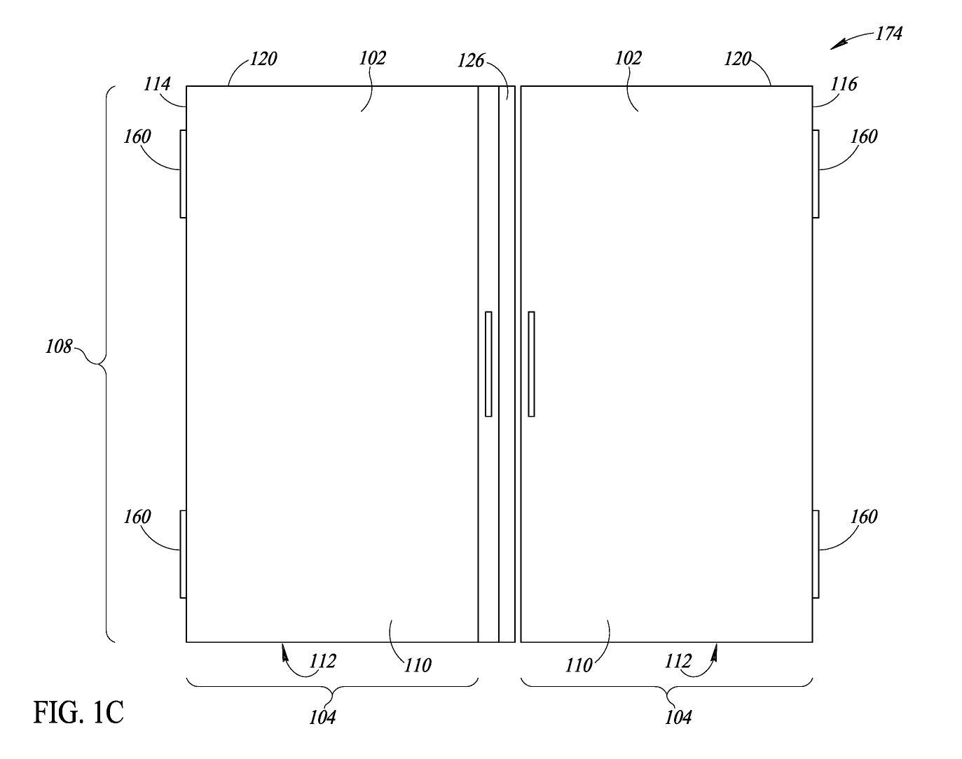

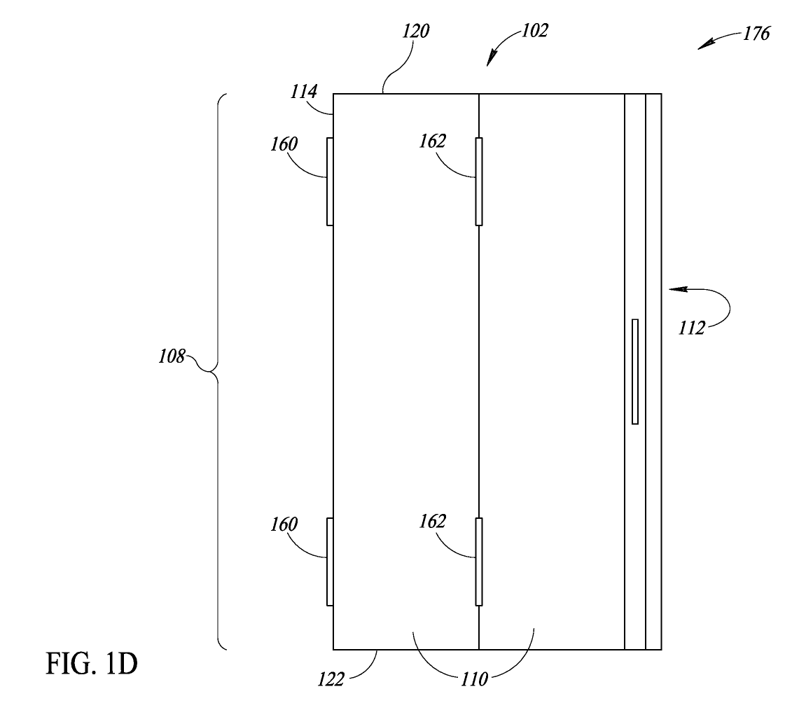

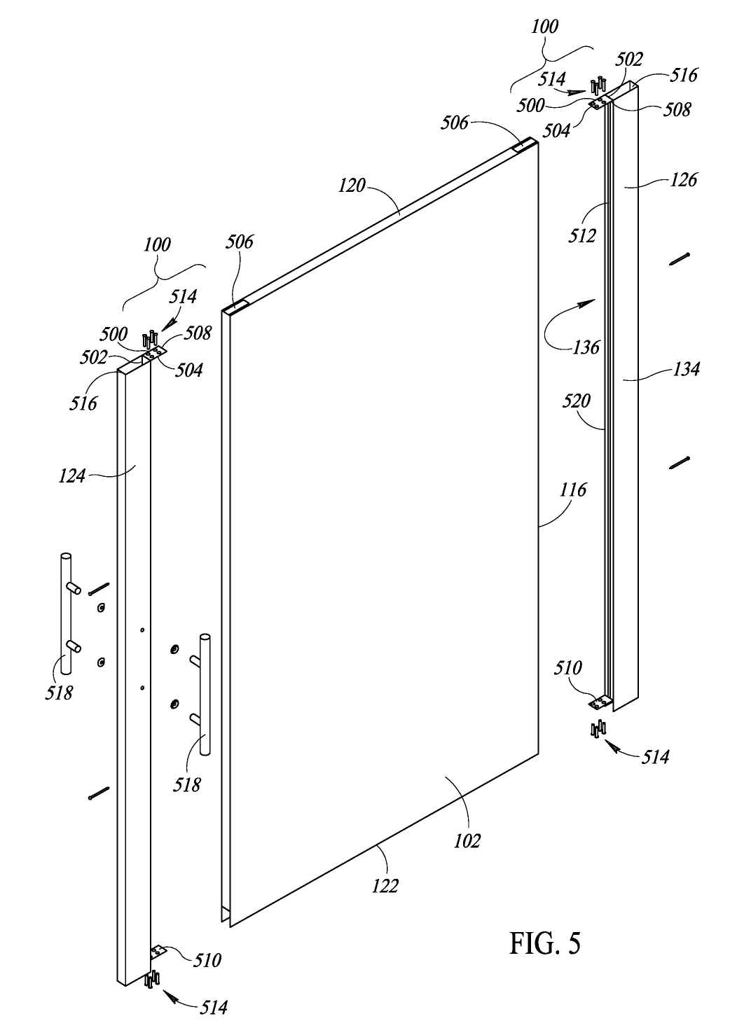

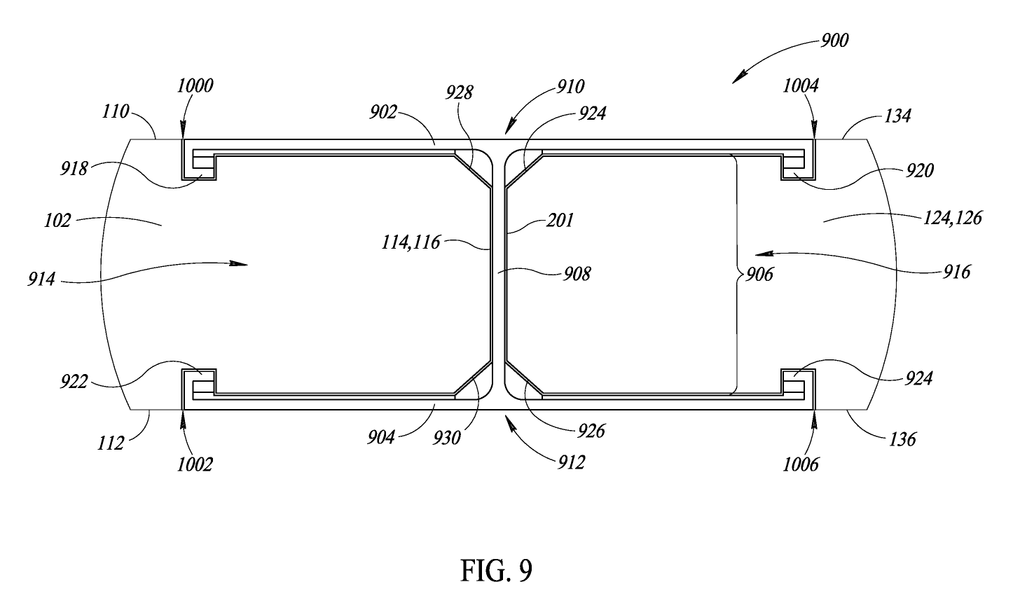

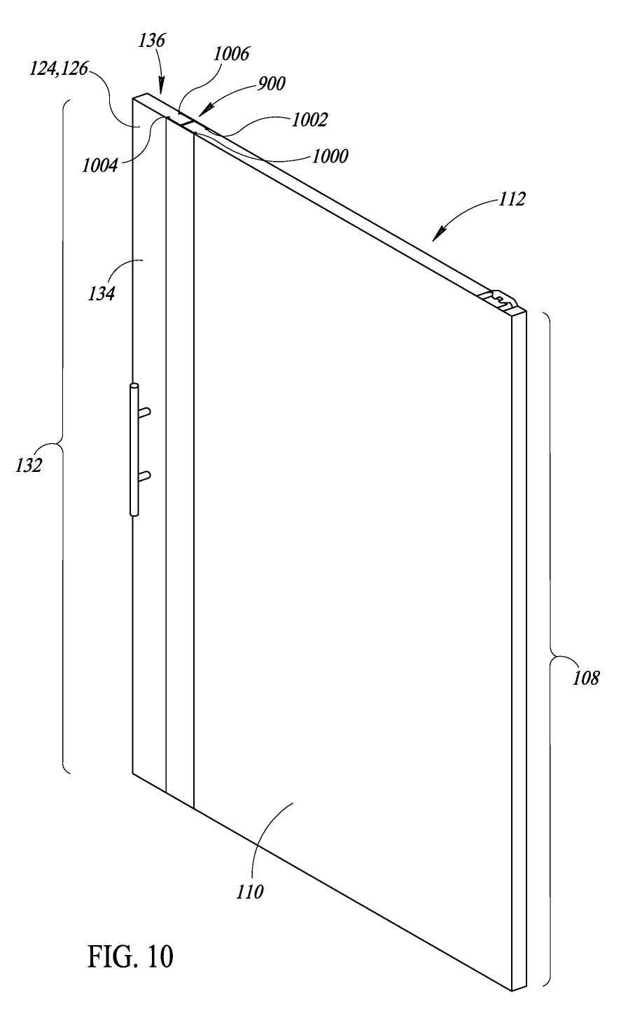

One or more implementations of the present disclosure relate to providing various extension panels for various doors, including doors comprised of sliding door panels, folding door panels, rotatable door panels, and swinging door panels. Initially, implementations for extension panels physically coupled to a vertical edge of a door using a mountable bracket and corresponding pin are discussed with reference to FIGS. 1A-4. Then, implementations for extension panels physically coupled to a door using top-mounted brackets are discussed with reference to FIGS. 5-8. Finally, implementations for extension panels physically coupled to a door using an H-bracket are discussed with reference to FIGS. 9 and 10. It should be appreciated that the various features of the implementations discussed herein may be modified or combined to provide doors having sealing characteristics desired for various particular applications.

FIG. 1A shows an extension panel apparatus 100 physically coupled to a door panel 102 in a sliding door configuration 170 such that the extension panel apparatus 100 is used to extend each of the sides of a door panel 102, thereby extending the overall length of the door. The door panel 102 may be included within various types of doors, such as sliding doors, swinging doors, rotating doors, and folding doors. The door panel 102 may have a length 104, a width or thickness 106, and a height 108, along with a front face 110 and an opposing back face 112. In some implementations, the length 104 of the door panel 102 may be about 48 inches. The front face 110 and the back face 112 may be contained in two parallel planes that are separated by the width 106 of the door panel 102. The door panel 102 may have two vertical edges, a left vertical edge 114 and a right vertical edge 116, that are separated by the length 104 and extend across the height 108 of the door panel 102. The door panel 102 may have a top edge 120 and a bottom edge 122 that are separated by the height 108 and extend across the length 104 of the door panel 102. The door panel 102 may be physically, movably coupled to a track 118, and may be translatable along the track 118 between a closed position (as shown), wherein the door panel 102 covers an opening in a wall, and an open position wherein the door panel 102 is moved towards the left to expose the wall opening. In some implementations, the door panel 102 may be configured to move towards the right to open.

The extension panel apparatus 100 may include two extension panels, a left extension panel 124 and a right extension panel 126. The left extension panel 124 may be physically coupled to and run along the left vertical edge 114, and the right extension panel 126 may be physically coupled to and run along the right vertical edge 116. As such, the extension panels 124, 126 may be used to effectively laterally extend the length 104 of the door panel 102 towards the left and/or right side of the door panel 102. Each extension panel(s) 124, 126 may have a length 128, a width 130, and a height 132, along with a front face 134 and an opposing back face 136. The length 128 of the extension panel may be, for example, about 3.5 inches, 5 inches, 7 inches, or more. The front face 134 and the back face 136 may be separated by the width 130 of the extension panel. In some implementations, one or both of the height 108 and/or the width 106 of the door panel 102 may be the same as, or substantially similar to, the height 132 and/or width 130 respectively of one or both of the extension panels 124, 126. As such, one or more of the extension panels 124, 126 may be aligned with the door panel 102 when the extension panel(s) 124, 126 are engaged with and physically coupled to the door panel 102. In such an aligned configuration, a top edge 138 of the extension panel(s) 124, 126 may be aligned with and located in the same plane as the top edge 120 of the door panel 102, and/or the front face 134 and back face 136 of the extension panel(s) 124, 126 may be aligned with and located in the same respective planes as the front face 110 and the back face 112 of the door panel 102.

FIGS. 1B through 1D show the door panel 102 in various door configurations, including a rotating door configuration 172 (FIG. 1B), a multiple-door panel, a swinging door configuration 174 (FIG. 1C), and a folding door configuration 176 (FIG. 1D). In each of these configurations, the door panel 102 may be physically coupled to a stationary structure, such as a wall, a post, or a door frame, using one or more coupling components 160 (e.g., rotatable coupling components), which may include, for example, hinges. The rotatable coupling components 160 may provide an axis of rotation that extends along one of the vertical edges 114/116 of the door panel 102, enabling the door panel to rotate about the axis of rotation to selectively cover or reveal a door opening. The door panel 102 in the folding door configuration 176 may further include a set of interior rotatable coupling components 162, such as, for example, one or more hinges, that enable the door panel 102 to fold in when being opened. One or more of the door panels 102 in each of the rotating door configuration 172, the multiple-door panel, swinging door configuration 174, and the folding door configuration 176 may be physically coupled to one or more extension panels 124, 126. It should be appreciated that some or all of the features of the present disclosure may be implemented in various types of doors.

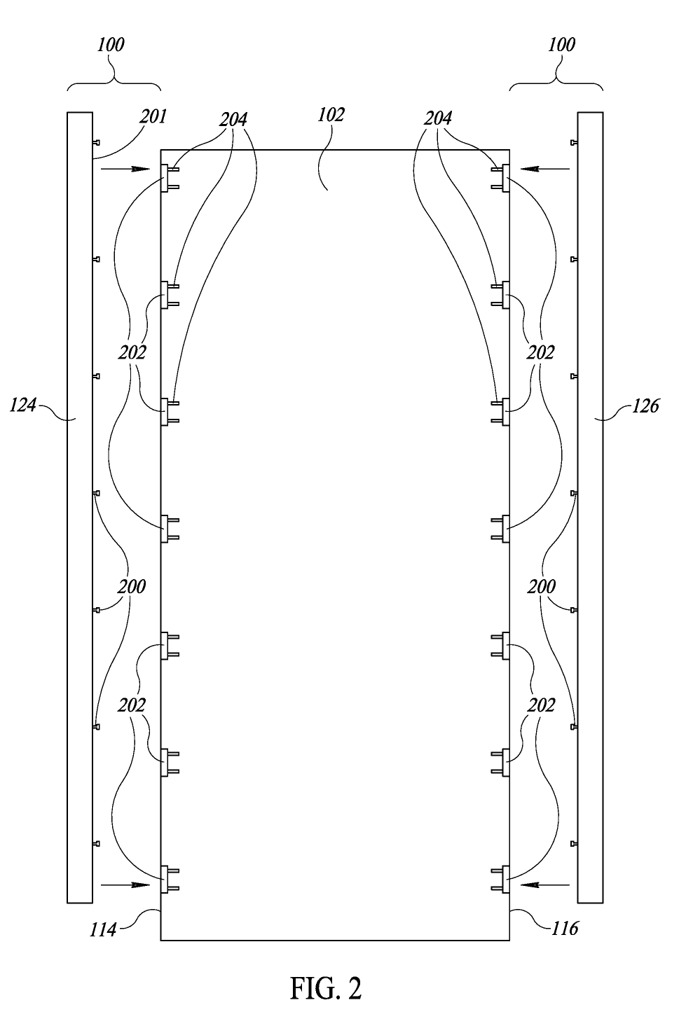

FIG. 2 shows an implementation of the extension panel apparatus 100 in which the extension panels 124, 126 couple with the door panel 102 via brackets 204 and corresponding elongated pins 200, according to at least one illustrated implementation. The extension panels 124, 126 each include a number of elongated pins 200 that are spaced along and extend outwards from the side edge 201 of the extension panel(s) 124, 126 proximate the door panel 102. The elongated pins 200 may be partially embedded within, or otherwise coupled to, the extension panel(s) 124, 126. For example, in some implementations, the elongated pins 200 may include coupling features (e.g., screws, bolts, dowels) that have been partially inserted into the extension panel(s) 124, 126 such that only a portion of a head of each screw remains exposed. In other implementations, a smooth dowel or other type of pin may be partially inserted into the extension panel(s) 124, 126.

The door panel 102 may include one or more cavities 202 that may be spaced along one or both of the vertical edges 114, 116 of the door panel 102. The cavities 202 may have an opening along the vertical edge(s) 114, 116 that leads to a recessed area that is contained within the interior of the door panel 102. Such cavities 202 may be spaced such that each cavity 202 may receive one of the elongated pins 200 extending outward from one of the extension panels 124, 126. In such an implementation, the recessed area for each cavity 202 may be sized and dimensioned to surround one of the brackets 204 that may be used to receive and securely engage one of the elongated pins 200 from the extension panel(s) 124, 126. The pins 200 and brackets 204 may be used to securely, detachably couple the extension panels 124, 126 to the respective vertical edge(s) 114, 116 of the door panel 102. As shown in FIG. 2, the extension panel(s) 124, 126 may be moved laterally towards the door panel 102 such that each elongated pin 200 enters a corresponding cavity 202 proximate a top portion of the opening to the corresponding cavity 202. As such, the elongated pin 200 may be engaged by an opening or channel in the bracket 204, as discussed further below. As discussed below, the extension panel 124, 126 may then be translated vertically downward to thereby securely engage each of the elongated pins 200 with corresponding ones of the brackets 204.

In at least some implementations, the positions of the elongated pins 200 and the brackets 204 may be reversed to that shown in FIG. 2, such that the brackets are securely coupled within cavities formed in the extension panel(s) 124, 126 and the corresponding elongated pins 200 are securely, partially inserted into one of the vertical edges 114, 116 of the door panel 102. In at least some implementations, the locations of the brackets 204 and corresponding elongated pins 200 may be mixed, such that some of the brackets 204 and some of the elongated pins 200 are located in the door panel 102, and complementary elongated pins 200 and brackets 204 are located in the extension panel(s) 124, 126. In at least some implementations, only one extension panel (e.g., either left extension panel 124 or right extension panel 126) may be securely, physically coupled to the door panel 102.

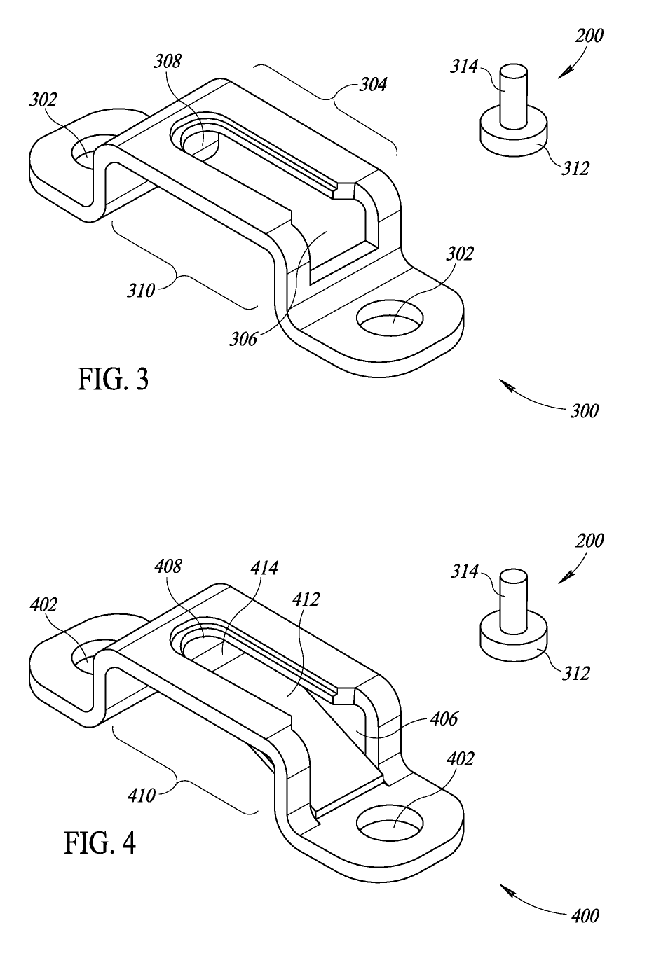

FIG. 3 and FIG. 4 show different implementations of brackets that may be located within the cavities 202 discussed above in connection with FIG. 2, along with a corresponding elongated pin 200 that may be securely, engageably inserted into the bracket. FIG. 3 shows a non-locking bracket 300 that may be securely, physically coupled to the door panel 102, such as, for example, within one of the cavities 202. The non-locking bracket 300 includes one or more apertures 302 (two shown) that may be sized and dimensioned to secure the non-locking bracket 300 to a surface of the cavity 202 using, for example, screws, bolts, tabs, or other similar coupling features. The non-locking bracket 300 may include a channel 304 that has a length 310 which extends along a portion of the length of the non-locking bracket 300.

The channel 304 for the non-locking bracket 300 may be comprised of an open end 306 and an opposing closed end 308 that are separated by the length 310 of the channel 304. The open end 306 of the channel 304 may be sized and dimensioned to receive an exposed portion of an elongated pin 200. In such an implementation, the elongated pin 200 may have a relatively large head or end portion 312 that is insertable into the open end 306 of the channel 304, but is larger than and therefore cannot pass through the remaining portion of the channel 304. The large head portion 312 of the elongated pin 200 may then narrow, either gradually or abruptly, towards a neck or shaft portion 314 in which the neck portion 314 can pass through the remaining part of the channel 304.

The non-locking bracket 300 may be securely attached within the cavity 202 and oriented such that the open end 306 of the channel 304 is vertically above the closed end 308 of the channel 304. Once the head portion 312 of the elongated pin 200 is inserted into the open end 306 of the channel 304, the elongated pin 200 may then be translated downward along the length 310 of the channel 304 until the head portion 312 of the elongated pin 200 reaches the closed end 308, which is located vertically lower than the open end 306. As such, a downward force (e.g., gravity) of the expansion panel(s) 124, 126 may keep the elongated pin 200 securely engaged with corresponding non-locking bracket 300, thereby securely, physically coupling the expansion panel(s) 124, 126 to the door panel 102.

FIG. 4 shows a locking bracket 400 that may be securely, physically coupled to the door panel 102, such as, for example, within one of the cavities 202. The locking bracket 400 includes one or more apertures 402 (two shown) that may be sized and dimensioned to secure the locking bracket 400 to a surface of the cavity 202 using, for example, screws, bolts tabs, or other similar coupling features. The locking bracket 400 may include a channel 404 that has a length 410 which extends along a portion of the length of the locking bracket 400.

The channel 404 for the locking bracket 400 may be comprised of an open end 406 and an opposing closed end 408 that are separated by the length 410 of the channel 404. In some implementations, the channel 404 may include a tab 412 that may be connected to the locking bracket 400 proximate the open end 406 and extends towards the closed end 408 of the channel 404. In at least some implementations, the tab 412 may be biased such that the portion of the tab located proximate the closed end 408 of the channel 404 touches and applies a force against the remaining portion of the locking bracket 400. The tab 412 may include a notch 414 at the portion of the tab 412 located proximate the closed end 408 of the channel 404. The open end 406 of the channel 404 may be sized and dimensioned to receive an exposed portion of an elongated pin 200. In such an implementation, the elongated pin 200 may have a relatively large head or end portion 312 that is insertable into the open end 306 of the channel 404, but is larger than and therefore cannot pass through the remaining portion of the channel 404. The large head portion 312 of the elongated pin 200 may then narrow, either gradually or abruptly, towards a neck or shaft portion 314 in which the neck portion 314 can pass through the remaining part of the channel 404.

The locking bracket 400 may be securely attached within the cavity 202 and oriented such that the open end 406 of the channel 404 is vertically above the closed end 408. Once the head portion 312 of the elongated pin 200 is inserted into the open end 406 of the channel 404, the elongated pin 200 may then be translated along the length 410 of the channel 404 until the head portion 212 of the elongated pin 200 reaches the closed end 408, which is located vertically lower than the open end 406. As the head portion 212 moves along the channel 404 towards the closed end 408 of the channel 404, the head portion 212 of the elongated pin 200 engages the tab 412, pushing the tab 412 away from the remaining portion of the locking bracket 400. When the head portion 212 of the elongated pin 200 reaches the notch 414, the head portion 212 may be sized and shaped to rest inside the notch 414, which may thereby secure the head portion 212 by pushing the head portion 212 of the elongated pin 200 against the portion of the bracket 400 proximate the closed end 408 of the channel 404. In some implementations, the elongated pin 200 may be secured to the locking bracket 400 via a downward force exerted by the expansion panel(s) 124, 126, thereby securely, physically coupling the expansion panel(s) 124, 126 to the door panel 102.

FIG. 5 shows an exploded view of an extension panel apparatus 100 that includes top-mounted brackets 500 that couple the extension panels 124, 126 to the door panel 102. In some implementations, the top-mounted brackets 500 may be L-shaped brackets with two legs, a first leg 502 and a second leg 504. The first leg 502 of the top-mounted bracket 500 may extend downward towards and be physically coupled to the extension panel(s) 124, 126, via, for example, a screw, tab, clip, or other coupling feature and/or via an adhesive. The second leg 504 may extend horizontally outwards from the extension panel(s) 124, 126 towards the door panel 102. The second leg 504 may include one or more apertures that may be used to couple the L-shaped bracket 500 to the top edge 120 of the door panel 102 using one or more coupling features 514, such as, for example, screws, bolts, tabs, clips, or other similar coupling features. In some implementations, recess(es) 506 may be provided within the top edge 120 proximate one or more of the vertical edges 114, 116 of the door panel 102. The recess 506 may be sized and shaped to receive the second leg 504 of the top-mounted bracket 500. In such implementations, the second leg 504 may rest in the recess 506 such that an upward-facing surface 508 of the second leg 504 may be aligned with the top edge 120 of the door panel 102, such that the upward-facing surface 508 is within a plane formed by the top edge 120 of the door panel 102. In some implementations, a handle 518 may be physically coupled to one or more of the extension panel(s) 124, 126 and/or the door panel 102 using suitable fastening hardware.

In some implementations, the extension panel(s) 124, 126 may include a bottom-mounted bracket 510 that may be engaged with the bottom edge 122 of the door panel 102 using one or more coupling features. One or more recesses may be provided within the bottom edge 122 such that the downward-facing surface of the bottom-mounted brackets 510 are aligned with and included within a plane formed by the bottom edge 122. Such a bottom-mounted bracket 510 may be used to support the extension panel(s) 124, 126 and/or to provide additional stability to the extension panel(s) 124, 126 to reduce the amount of wobbling or other movement by the extension panel(s) 124, 126 relative to the door panel 102. In some implementations, one or more coupling features 514, such as screws, bolts, or nails, may be inserted into a vertical edge 516 of the extension panel(s) 124, 126 such that the coupling features 514 pass through the extension panel(s) 124, 126 and enter and become securely engaged within the corresponding vertical edge(s) 114, 116 of the door panel 102.

In some implementations, the extension panel(s) 124, 126 may include a groove 512 that extends along a vertical edge 520 of the of the extension panel(s) 124, 126 that is proximate the door panel 102. As discussed below, the groove 512 may include a cavity formed by two legs that extend laterally from the front face 134 and the back face 136, respectively, of the extension panel(s) 124, 126. The cavity may be sized and shaped to receive and surround a portion of the door panel 102 when the extension panel(s) 124, 126 is securely, physically coupled to the door panel 102.

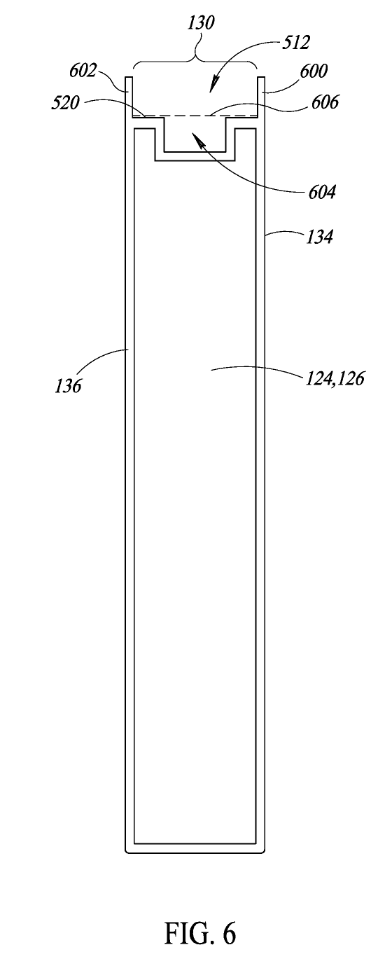

FIG. 6 shows an extension panel(s) 124, 126 that includes a groove 512 that may extend along the vertical edge 520 of the extension panel(s) 124, 126 that is proximate the door panel 102. The groove 512 may be formed by a first leg 600 that extends laterally from a front face 134 of the extension panel(s) 124, 126, and an opposing second leg 602 that extends laterally from the back face 136 of the extension panel(s) 124, 126. The first leg 600 and the second leg 602 may be perpendicular to the vertical edge 520 of the extension panel(s) 124, 126. The first leg 600 and the second leg 602 may be separated by the width 130 of the extension panel(s) 124, 126.

In some implementations, the groove 512 may include a cavity 604 that may form a further indentation within the vertical edge 520 of the extension panel(s) 124, 126. Such a cavity 604 may be used, for example, to receive one or more brackets (e.g., non-locking bracket 300 and/or locking bracket 400) that may be used to securely, detachably, physically couple the extension panel(s) 124, 126 to the door panel 102. As such, the vertical edge(s) 114, 116 of the door panel 102 may be inserted into the groove 512 until the vertical edge(s) 114, 116 comes into contact with the vertical edge 520 of the extension panel(s) 124, 126. In this implementation, the door panel 102 may be inserted into the groove 512 until the vertical edge(s) 114, 116 of the door panel 102 reach a plane 606 formed by the vertical edge 520 of the extension panel(s) 124, 126, at which point the door panel 102 and the extension panel(s) 124, 126 may be securely, physically coupled together (e.g., via brackets and pins, as discussed above). In such an implementation, the first leg 600 of the extension panel(s) 124, 126 may extend around and cover a portion of the front face 110 of the door panel 102, and the second leg 602 of the extension panel(s) 124, 126 may extend around and cover a portion of the back face 112 of the door panel 102. Such an implementation may provide a cleaner, more pleasing line and appearance for the junction between the door panel 102 and the extension panel(s) 124, 126. Such an implementation may also or alternatively provide for better noise reduction when the door panel 102 and the extension panel(s) 124, 126 are coupled.

In some implementations, a portion of the front face 110 and/or back face 112 of the door panel 102 proximate the vertical edge(s) 114, 116 may be removed to facilitate the placement of the first leg 600 and the second leg 602 over the door panel 102. As such, the first leg 600 and the second leg 602 of the extension panel(s) 124, 126 may be aligned and in the same plane as the front face 110 and back face 112, respectively, of the door panel 102.

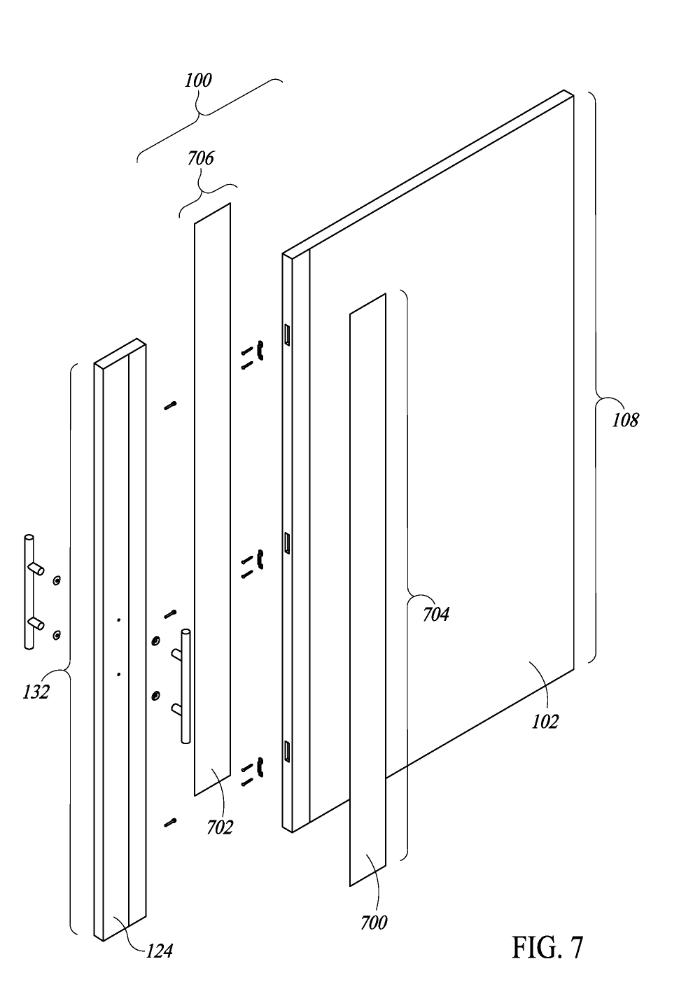

FIG. 7 shows another implementation of an extension panel apparatus 100 that includes a first cover panel 700 and a second cover panel 702 that are mounted over a junction of the door panel 102 and the left extension panel 124, according to one illustrated implementation. The first cover panel 700 and the second cover panel 702 may have a height 704 that is the same as, or substantially similar to, the height 108 of the door panel 102 and/or the height 132 of the left extension panels 124. The first cover panel 700 and the second cover panel 702 may have a length 706 sufficient to cover a junction of the door panel 102 and the left extension panel 124 when the door panel 102 and the left extension panel 124 are coupled together. Such a length 706 may be, for example, between 2 inches and 7 inches or more. In some implementations, the first cover panel 700 and/or the second cover panel 702 may be comprised of a metal or alloy material that may provide a contrast to the material (e.g., wood, wood veneer, manufactured particle board) used to comprise the door panel 102 and/or the left extension panel 124. The metal material may be, for example, nickel, brushed nickel, aluminum, copper, or some other metal or alloy.

In some implementations, portions of the door panel 102 and the left extension panel 124 may be removed proximate the junction between the door panel 102 and the left extension panel 124. The removed portions may, for example, facilitate the installation of the first cover panel 700 and/or the second cover panel 702 over the junction such that the surface of the first cover panel 700 is aligned with and in the same plane as the front face 110 of the door panel 102 and the front face of the left extension panel, and such that the surface of the second cover panel 702 is aligned with and in the same plane as the back face 112 of the door panel 102 and the back face of the left extension panel. The first cover panel 700 and the second cover panel 702 may be securely, physically coupled to the door panel 102 and/or the extension using one or more physical coupling features (e.g., bolts, screws, nails, or tabs) that my securely, detachably couple the first cover panel 700 and/or the second cover panel 702 to the door panel 102 and/or the left extension panel 124. Although the above description has been made with regard to the left extension panel 124, the first cover panel 700 and the second cover panel 702 may be used with either or both of the left extension panel 124 and right extension panel 126.

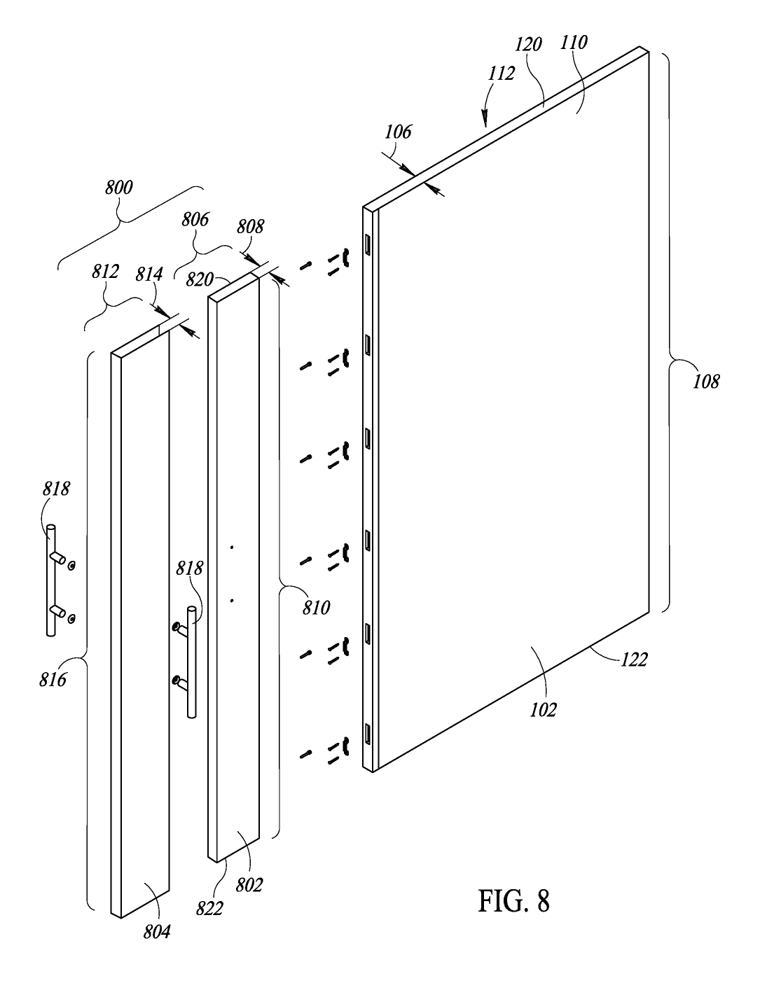

FIG. 8 shows an implementation of an extension panel apparatus in which an extension panel 800 is comprised of a filler component 802 and a cap component 804. The filler component 802 may have a length 806, a width 808, and a height 810, and may be securely, physically coupled to the door panel 102 using, for example, any one or more of the non-locking bracket 300, the locking bracket 400, the top-mounted bracket 500, and/or the bottom-mounted bracket 510, as discussed above. The height 810 of the filler component 802 may be the same as or substantially similar to the height 108 of the door panel 102, and the width 808 of the filler component 802 may be the same as or substantially similar to the width 106 of the door panel 102. As such, a top edge 820 and a bottom edge 822 of the filler component 802 may be aligned with the top edge 120 and the bottom edge 122, respectively, of the door panel 102 when the filler component 802 is physically coupled to the door panel 102. The filler component 802 may be comprised of an inexpensive material, such as, for example, wood, manufactured particle board, or some other similar material.

The cap component 804 may be comprised of a U-shaped structure that is sized and dimensioned to extend around and cover the filler component 802. The cap component 804 may have a length 812, a width 814, and a height 816. The height 816 of the cap component 804 may be the same as or substantially similar to the height 810 of the filler component 802. In some implementations, the length 812 of the cap component 804 may be longer than the length 806 of the filler component 802. In such an implementation, the cap component 804 may extend past the filler component 802 such that the cap component 804 may extend at least partially over the front face 110 and/or the back face 112 of the door panel 102. The cap component 804 may be comprised of a durable material, such as nickel, brushed nickel, aluminum, copper, or some other similar type of durable metal or other material. The cap component 804 may be physically coupled with the filler component 802 using one or more coupling features, such as, for example, screws, nails, bolts, or some other similar component. In some implementations, a door handle 818 may be physically coupled to one or both of the cap component 804 and the filler component 802 to facilitate the movement of the door panel 102.

FIGS. 9 and 10 show another type of connector, a bracket 900, that may be used to securely, physically couple the door panel 102 to the extender panel(s) 124, 126. The bracket 900 may have a shape of an “H” with a first plate 902 and a parallel second plate 904 separated by a distance 906. A cross-member 908 may extend across the distance 906 to connect the first plate 902 and the second plate 904. In some implementations, the cross-member 908 may connect at or near a midline 910 of the first plate 902 and a midline 912 of the second plate 904. As such, the first plate 902, the second plate 904, and the cross-member 908 may form a first cavity 914 and a second cavity 916. The bracket 900 may extend along the height 108 of the door panel 102 and/or the height 132 of the extension panel(s) 124, 126. In some implementations, the first plate 902, the second plate 904, and the cross-member 908 may form one integrated unit or component (e.g., an extrusion).

In some implementations, the first plate 902 may include a first ridge 918 located at a first end of the first plate 902, and a second ridge 920 located at a second, opposing end of the first plate 902. The second plate 904 may include a third ridge 922 located at a first end of the second plate 904 and opposite the first ridge 918 across the first cavity 914. The second plate 904 may include a fourth ridge 924 located at a second, opposing end of the second plate 904 and opposite the second ridge 920 across the second cavity 916. The first ridge 918 and the opposing third ridge 922 may be sized and spaced to engage with corresponding grooves 1000, 1002 located on the front face 110 and back face 112, respectively, of the door panel 102 when the bracket 900 is engaged with the door panel 102. As such, the portions of the bracket 900 forming the first cavity 914 may surround at least a portion of the door panel 102. Similarly, the second ridge 920 and the opposing fourth ridge 924 may be sized and spaced to engage with corresponding grooves 1004, 1006 located on the front face 134 and back face 136, respectively, of the extension panel(s) 124, 126 when the bracket 900 is engaged with the extension panel(s) 124, 126. As such, the portions of the bracket 900 forming the second cavity 916 may surround at least a portion of the extension panel(s) 124, 126.

In some implementations, frictional forces between the ridges and the corresponding grooves may be sufficient to securely, physically couple the extension panel(s) 124, 126 to the door panel 102. The door panel 102 may be coupled to the bracket 900 by inserting the vertical edge (i.e., left vertical edge 114 or right vertical edge 116) of the door panel 102 into the opening formed by first ridge 918 and third ridge 922. The door panel 102 may include one or more beveled edges, such as front beveled edge 928 and back beveled edge 930, to facilitate the entry of the door panel 102 into the first cavity 914 formed by the bracket 900 by deflecting outward the portion of the first plate 902 proximate the first ridge 918 and the portion of the second plate 904 proximate the third ridge 922. The door panel 102 may be laterally translated towards the cross-member 908 until the grooves 1000, 1002 align with the corresponding first ridge 918 and third ridge 922, respectively. When the grooves 1000, 1002 align with the corresponding first ridge 918 and third ridge 922, the first ridge 918 and the third ridge 922 may snap into the grooves 1000, 1002 to thereby secure the door panel 102 to the bracket 900. The extension panel(s) 124, 126 may be coupled to the bracket 900 by inserting the side edges 201 of the extension panel(s) 124, 126 into the opening formed by second ridge 920 and fourth ridge 924. The extension panel(s) 124, 126 may include one or more beveled edges, such as front beveled edge 924 and back beveled edge 926, to facilitate the entry of the extension panel(s) 124, 126 into the second cavity 916 formed by the bracket 900 by deflecting outward the portion of the first plate 902 proximate the second ridge 920 and the portion of the second plate 904 proximate the fourth ridge 924. The extension panel(s) 124, 126 may be laterally translated towards the cross-member 908 until the grooves 1004, 1006 align with the corresponding second ridge 920 and fourth ridge 924, respectively. When the grooves 1004, 1006 align with the corresponding second ridge 920 and fourth ridge 924, the second ridge 920 and the fourth ridge 924 may snap into the grooves 1004, 1006 to thereby secure the extension panel(s) 124, 126 to the bracket 900. In some implementations, an adhesive material may be used to adhere the extension panel(s) 124, 126 and the door panel 102 to the bracket 900.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of various implementations. Those of skill in the art will recognize that many of the examples set out herein may employ additional elements and/or may omit some elements. The various implementations described above can be combined to provide further implementations.

The various implementations described above can be combined to provide further implementations. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. This application also claims the benefit of U.S. Provisional Patent Application No. 62/563484, filed Sep. 26, 2017, and is incorporated herein by reference in its entirety. Aspects of the implementations can be modified, if necessary, to employ systems, circuits and concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An extension panel apparatus for a door, the door having a length, a width, a height, two opposing vertical edges located across the length of the door that extend along the height of the door, a front face and an opposing back face separated by the width of the door, and a top edge and an opposing bottom edge separated by the height of the door, the extension panel apparatus comprising:
an extension panel having a length, a width, and a height, and which includes two vertical edges separated by the length of the extension panel;
at least one elongated pin which extends outward from the one of the vertical edges of the extension panel; and
a connector physically coupled to the door proximate one of the vertical edges of the door, in operation the connector physically engages with the at least one elongated pin to couple the extension panel to the door along the one of the vertical edges of the door.

2. The extension panel apparatus of claim 1 wherein the height of the extension panel is at least substantially the same as the height of the door.

3. The extension panel apparatus of claim 1 wherein the at least one elongated pin extends outward from the width of the extension panel, wherein the connector comprises a bracket that includes a channel having an open end facing upward and an opposing closed end, and wherein the elongated pin is sized and dimensioned to be insertable into the open end of the channel.

4. The extension panel apparatus of claim 3 wherein the connector is located within a cavity located along the one of the vertical edges of the door.

5. The extension panel apparatus of claim 3 wherein the elongated pin has a head portion that is insertable into the open end of the channel of the bracket.

6. The extension panel apparatus of claim 3 wherein the bracket further includes a tab that engages with the elongated pin when the elongated pin is positioned proximate the closed end.

7. The extension panel apparatus of claim 1 wherein the extension panel includes a groove formed along at least one of the vertical edges of the extension panel, wherein the door is sized and dimensioned to fit at least a portion of the door into the groove such that the front face and the back face of the door align with corresponding portions of the extension panel.

8. The extension panel apparatus of claim 1 wherein at least a portion of the connector extends vertically past at least one of the vertical edges of the door and securely physically couples to the top edge of the door.

9. The extension panel apparatus of claim 8 wherein the elongated pin comprises a screw, wherein the screw is physically insertable into a corresponding aperture in the connector.

10. The extension panel apparatus of claim 8 wherein a recess is formed along the top edge of the door, and wherein the recess is sized, shaped, and positioned to receive the connector such that an upward-facing surface of the connector aligns with the top edge of the door.

11. The extension panel apparatus of claim 8, further comprising:
a second connector, wherein at least a portion of the second connector extends vertically past the at least one vertical edge of the door and securely physically couples to the bottom edge of the door.

12. The extension panel apparatus of claim 1, further comprising:
a second extension panel having a length, a width, and a height, and which includes a two vertical edges separated by the length of the second extension panel;
a second elongated pin which extends outward from one of the vertical edges of the second extension panel; and
a second connector which physically engages with the second elongated pin to physically couple the second extension panel to the door adjacent to the other one of the vertical edges of the door.

13. The extension panel apparatus of claim 12 wherein the height of the second extension panel is at least substantially the same as the height of the door.

14. The extension panel apparatus of claim 1 wherein the extension panel has a front face and an opposing back face, the front face and the back face separated by the width of the extension panel, wherein the extension panel further includes a first leg that extends laterally from the front face of the extension panel, and a second leg that opposes the first leg and extends laterally from the back face of the extension panel, the first leg and the second leg forming a groove that at least partially extends around the front face and the back face of the door when the extension panel is detachably, physically coupled to the door.

15. An extension panel apparatus for a door, the door having a length, a width, a height, two opposing vertical edges located across the length of the door that extend along the height of the door, a front face and an opposing back face separated by the width of the door, a top edge and an opposing bottom edge separated by the height of the door, and a first door groove on the front face that extends from the top edge to the bottom edge and a second door groove on the back face that extends from the top edge to the bottom edge, the extension panel apparatus comprising:
an extension panel having a length, a width, a height, a front face, a back face, and a first extender groove on the front face of the extension panel and a second extender groove on the back face of the extension panel, in which the first extender groove and the second extender groove extend along the height of the extension panel; and
a bracket having a first plate, an opposing second plate, and a cross-member which connects the first plate and the second plate of the bracket to form a first cavity and a second cavity, in which a first portion of the bracket that forms the first cavity is sized and dimensioned to at least partially surround at least one vertical edge of the door, and in which a second portion of the bracket that forms the second cavity is sized and dimensioned to at least partially surround at least at least one vertical edge of the extension panel.

16. The extension panel apparatus of claim 15, wherein the bracket includes a first set of two engageable ridges opposite each other across the first cavity and a second set of two engageable ridges opposite each other across the second cavity, wherein each of the engageable ridges in the first set is sized and dimensioned to securely, physically couple with a separate one the first door groove and the second door groove in the door, and wherein each of the engageable ridges in the second set of engageable ridges is sized and dimensioned to securely, physically couple with a separate one the first extender groove and the second extender groove in the extension panel.

17. The extension panel apparatus of claim 15, wherein the bracket extends along the height of the door.
